(19) United States
(12) Patent Application Publication
(10) Pub. No.: US 2026/0296710 A1
(43) Pub. Date: Oct. 1, 2026

(54) LABEL AFFIXING DEVICE

(71) Applicant: BROTHER KOGYO KABUSHIKI KAISHA, Nagoya (JP)

(72) Inventors: Ryuichi KANDA, Nagoya (JP); Shota IIJIMA, Nagoya (JP); Masashi TANIZAKI, Kuwana (JP); Tomohiro WADA, Nagoya (JP); Yuya NAKAMURA, Nagoya (JP); Yoshimi IWAMOTO, Nagoya (JP)

(21) Appl. No.: 19/437,268

(22) Filed: Dec. 30, 2025

(30) Foreign Application Priority Data
Mar. 31, 2025 (JP) 2025-059458

(51) Int. Cl. B65C 9/26; B65C 9/00; B65C 9/18; B65C 9/46

(52) U.S. Cl. CPC B65C 9/26; B65C 9/0006; B65C 9/1807; B65C 9/1892; B65C 9/46; B65C 2009/0096

(57) ABSTRACT

A label affixing device affixes a label to a rod-shaped member and includes a compartment to receive a medium, a convey portion to convey the medium, a peeling portion to peel the label from the medium, and a winding portion to wind the release material with the label peeled off. The medium includes a label and a release material. The convey portion includes a drive roller and a drive shaft. The winding portion includes a reel to wind the release material on an outer peripheral surface thereof, and a reel shaft rotatably supporting the reel. A roll with the release material wound by the winding portion is removed from the reel in a first direction along an axial direction of the reel shaft. The medium is removed from the compartment in the first direction along the axial direction of the drive shaft.

### SPECIFICATION

### REFERENCE TO RELATED APPLICATIONS

This application claims priority from Japanese Patent Application No. 2025-059458 filed on Mar. 31, 2025. The entire content of the priority application is incorporated herein by reference.

### BACKGROUND ART

A label affixing device is known that affixes a label to a rod-shaped member. The label affixing device prints on a tape fed from a tape cassette to produce a label. The label affixing device completely removes the label from a release material and affixes the label to a cable by wrapping the label around the cable. The release material is discharged to the outside from a discharge portion at the upper end portion of the housing.

### SUMMARY

In the known label affixing device, for example, when the tape is used up, a second cover is opened and the tape cassette is replaced. The tape is cut, conveyed, and discharged to the outside from the discharge portion at the upper end portion of the housing. Because the direction for removing the tape cassette from the tape accommodating portion and the direction in which the tape is discharged from the discharge portion are different, the work required for replacing the tape cassette is cumbersome.

An object of the present disclosure is to provide a label affixing device that can reduce the work involved in replacing a medium.

One aspect of the present disclosure provides a label affixing device having the following features. The label affixing device includes a compartment, a print portion, a convey portion, a peeling portion, a winding portion. The compartment is included in a housing and is configured to receive a medium. The medium includes a label and an adhesive medium. The adhesive medium is formed by an adhesive material and a release material by adhering together. The print portion is configured to print an image onto the label of the medium provided from the compartment.

The convey portion is configured to convey the medium printed by the print portion. The peeling portion is configured to peel the label from the medium conveyed by the convey portion. The medium is formed by adhering the label and adhesive material together. The winding portion is configured to wind the release material with the label peeled off by the peeling portion. The label affixing device is a device that affixes the label, peeled off by the peeling portion, to a rod-shaped member to be affixed the label.

In the label affixing device configured as described above, the winding portion includes a reel and a reel shaft. The reel is configured to wind the release material on an outer peripheral surface of the reel. The reel shaft is fixed to the housing and rotatably supports the reel.

The convey portion includes a convey roller, a drive roller, and a drive shaft. The drive roller is configured to convey the medium by pinching the medium between a nip portion with the covey roller. The drive shaft is configured to transmit driving force to the drive roller.

When a roll wound with the release material wound by the winding portion is removed from the reel, the roll is removed in a first direction along an axial direction of the reel shaft. When the medium is removed from the compartment, the medium is removed in a second direction along the axial direction of the drive shaft. The first direction and the second direction are in a same direction.

When the medium is used up or when the medium is replaced midway, the medium is removed from the compartment, and the roll wound with the release material is also removed from the reel. The first direction in which the roll is removed from the reel and the second direction in which the medium is removed from the compartment are the same direction. Accordingly, the user can perform both the operation of removing the medium from the compartment and the operation of removing the roll from the reel from the same direction with respect to the label affixing device. Therefore, the label affixing device can reduce the work involved in replacing the medium.

### BRIEF DESCRIPTION OF DRAWINGS

FIG. 1 is a perspective view of a label affixing device.

FIG. 2 is a perspective view of the label affixing device with a main cover opened.

FIG. 3 is an enlarged cross-sectional view of the area within the double-dashed line in FIG. 2.

FIG. 4 is an enlarged right side view of the area within the double-dashed line in FIG. 2.

FIG. 5 is a perspective view of a cutting portion as seen from the upper left front side.

FIG. 6 is a front view of a full-cut cutting blade.

FIG. 7 is an exploded perspective view of a winding portion.

FIG. 8 is a view illustrating the removal of a release material roll and a tape cassette from a housing.

FIG. 9 is a perspective view of a label affixing device having a main cover according to a modified example.

### DESCRIPTION

An embodiment of a label affixing device 1 embodying the present disclosure will be described with reference to the drawings. The referenced drawings are used to illustrate the technological features that can be adopted by the present disclosure, and illustrated configurations of devices, for example are not intended to limit the present disclosure, and are simply explanatory examples.

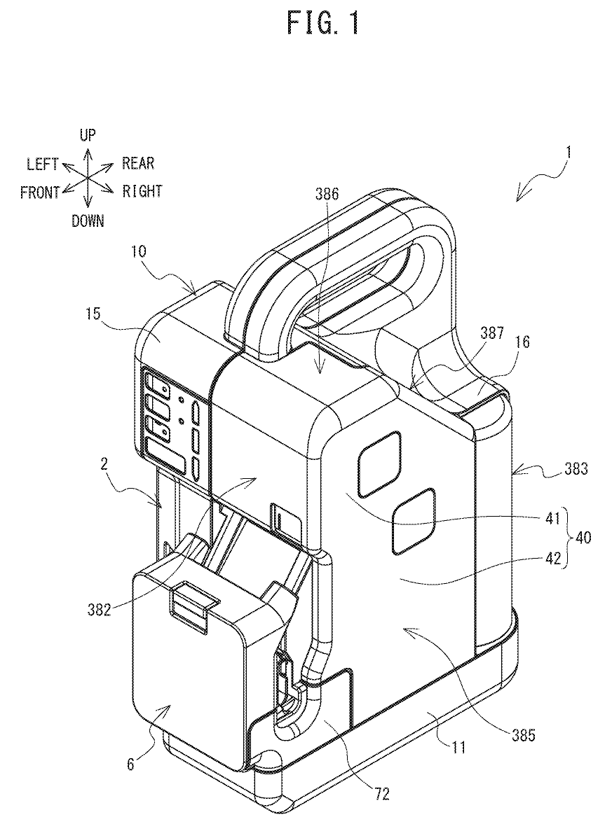

The label affixing device 1 is a device that produces a label 160 by printing an image on a tape 150 and affixes the produced label 160 to a cable 19 by wrapping the label 160 around the cable 19. A lower left direction, an upper right direction, an upper left direction, a lower right direction, an upward direction, and a downward direction in FIG. 1 respectively correspond to a front direction, a rear direction, a left direction, a right direction, an upper direction, and a lower direction of the label affixing device 1.

### Overview of label affixing device 1

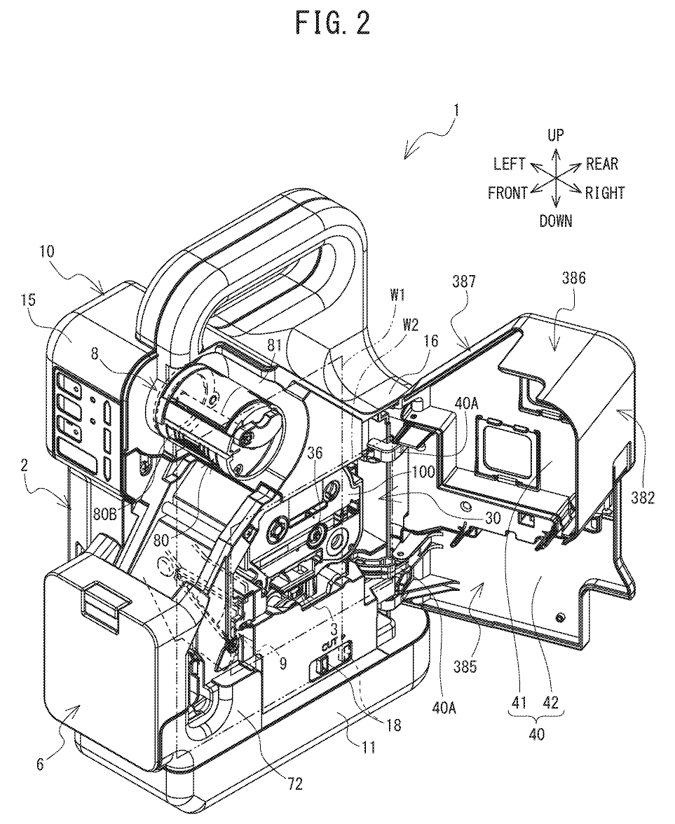

As shown in FIGS. 1 and 2, the label affixing device 1 includes a box-shaped housing 10. The housing 10 includes a base 11, a main unit 2, a main plate, a left cover 15, a rear cover 16, a main cover 40, a compartment 30, a print mechanism 3, and a cutting portion 9.

The base 11 serves as the foundation of the label affixing device 1. The base 11 has a rectangular box shape, and, in a plan view, has a shape in which the front left corner is cut off. The base 11 receives a power supply board and battery, etc.

The main unit 2 is a unit that peels off the label 160 from the tape 150 printed by the print mechanism 3 and winds the label 160 around the cable 19. The main unit 2 includes a peeling portion 4, a pressing portion 25, an opening/closing portion 6, and a wrapping portion 7. A lower end portion of the main unit 2 is fixed to the base 11. The main unit 2 will be described later.

The main plate is a plate-like support member extending in the up-down direction and front-rear direction, and is fixed to the housing 10. The main plate is disposed to the left of the center in the left-right direction of the base 11 and extends upward. The lower end portion of the main plate is fixed to the lower end portion of the main unit 2 within the base 11. The main plate supports a drive unit, the compartment 30, the print mechanism 3, and the winding portion 8 on the right, the cutting portion 9 at the front end portion, and a control unit on the left. The control unit controls the operation of the label affixing device 1. The drive unit drives the print mechanism 3.

The compartment 30 is disposed to the right of the main plate. The print mechanism 3 is disposed below the compartment 30. The cutting portion 9 is disposed in front of the compartment 30. The winding portion 8 is disposed diagonally upward in front of the compartment 30.

The left cover 15 is arranged on the left of the main plate, and constitutes the front surface, the rear surface, the top surface, and the left surface of the left portion of the housing 10, which is to the left of the center of the housing 10 in the left-right direction. The left cover 15 covers and protects the control unit disposed on the left surface of the main plate. The rear cover 16 is arranged on the right of the main plate, and constitutes the rear surface and top surface of the right portion of the housing 10, which is to the right of the center of the housing 10 in the left-right direction. The rear cover 16 covers and protects the compartment 30, disposed on the right surface of the main plate, from the rear.

The main cover 40 is disposed to the right of the main plate, and covers and protects the compartment 30 and the winding portion 8 from the right. At the rear edge of the main cover 40, hinges 40A that are pivotally supported by the front surface of the left end portion of the rear cover 16 are disposed at two locations in the up-down direction. Accordingly, the front end of the main cover 40 pivots about the rear end in the left-right direction, thereby opening and closing the compartment 30 and the winding portion 8. That is, the main cover 40 pivots between a closed state, in which it covers the compartment 30 and the winding portion 8, and an open state, in which it does not cover the compartment 30 and the winding portion 8.

The main cover 40 includes a first cover portion 41 and a second cover portion 42. The first cover portion 41 is arranged around the periphery of the winding portion 8 when in the closed state, and is positioned in a location away to the right from the winding portion 8 when in the open state. The second cover portion 42 is positioned to the right of the compartment 30 when in the closed state, and is positioned at a location away to the right from the compartment 30 when in the open state. The first cover portion 41 and the second cover portion 42 are integrally formed.

The main cover 40 includes a front wall 382, a rear wall 383, a right wall 385, a top wall 386, and an inclined wall 387. The front wall 382, the rear wall 383, the top wall 386, and the inclined wall 387 protrude in a plate shape to the left towards the center portion of the housing 10 in the left-right direction from the front end, the rear end, the front upper end, and the rear upper end, respectively, of the right wall 385. Each of the front wall 382, the rear wall 383, the top wall 386, and the inclined wall 387 constitute the front surface, the rear surface, the front portion of the top surface, and the rear portion of the top surface, respectively, of the right portion of the housing 10 that is to the right of the center in the left-right direction of the housing 10. The top wall 386 faces upward, and the inclined wall 387 is inclined to face diagonally upward to the rear.

When the main cover 40 is closed, the portion enclosed by the right wall 385, the front wall 382, and the top wall 386 covers and protects a reel 80 of the winding portion 8. That is, the right wall 385 covers the right surface of the reel 80 from the right. The front wall 382 and the top wall 386 cover an outer peripheral surface 80B of the reel 80 from the front and from above, respectively.

The first cover portion 41 includes an upper portion of the right wall 385, the front wall 382, and an upper portion of the rear wall 383, as well as the top wall 386 and the inclined wall 387. The second cover portion 42 includes a lower portion of the right wall 385 and a lower portion of the rear wall 383.

The compartment 30 has a box-like shape that opens to the right, and is capable of accommodating various of tape cassettes such as thermal-type tape cassettes, receptor-type tape cassettes, and laminate-type tape cassettes. The thermal-type tape cassette includes a thermal paper tape. The receptor-type tape cassette includes a tape and an ink ribbon.

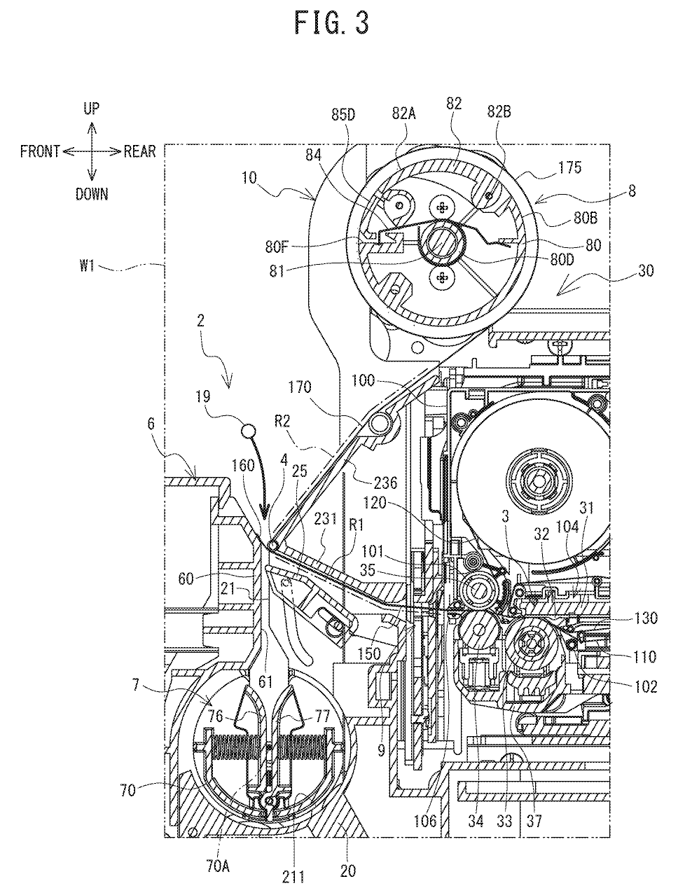

As shown in FIG. 3, the tape cassette used in the label affixing device 1 of the present embodiment is a laminate-type tape cassette 100. The laminate-type tape cassette 100 includes a film tape 110, a double-sided adhesive tape 120, and an ink ribbon 130. The film tape 110 is a transparent tape made of PET. The double-sided adhesive tape 120 is a tape in which a base material and a release material 170 are laminated via an adhesive. The tape cassette 100 will be described later.

### Print mechanism 3

As shown in FIGS. 2-4, the print mechanism 3 is arranged below the compartment 30. The print mechanism 3 includes a head holder 31, a thermal head 32, a drive shaft 35, a winding shaft 36, a platen roller 33, and a convey roller 34. The head holder 31 is located at the lower portion of the compartment 30. The head holder 31 has a plate shape and extends in both the front-rear direction and left-right direction.

The thermal head 32 is on the lower surface of the head holder 31. The thermal head 32 includes a plurality of heating elements. The plurality of heating elements are arranged in a single row in the left-right direction. In a state where the tape cassette 100 is installed in the compartment 30, the thermal head 32 heats the ink ribbon 130 by the plurality of heating elements. When the ink ribbon 130 is heated, the ink is transferred onto the film tape 110.

The head holder 31 not only supports the thermal head 32 but also functions as a heat sink for the heating elements. The drive shaft 35 for conveying the tape 150 is disposed diagonally below and to the front of the head holder 31. The drive shaft 35 extends to the right from the bottom surface of a recessed portion of the compartment 30 and is rotationally driven by a convey motor. When the tape cassette 100 is installed, the drive shaft 35 engages with a shaft hole in a drive roller 101 of the tape cassette 100.

The winding shaft 36 is disposed diagonally above and to the rear of the head holder 31. The winding shaft 36 is rotationally driven by the driving force of the convey motor. When the tape cassette 100 is installed, the winding shaft 36 engages with a winding spool 132 of the tape cassette 100.

A platen holder 37 is disposed below the head holder 31. The platen holder 37 has an arm shape, and has a support shaft extending in the left-right direction on a rear end portion. The platen holder 37 is supported rotatably about the axis of the support shaft. The platen roller 33 and the convey roller 34 are rotatably supported at the distal end portion of the platen holder 37. The platen roller 33 comes into and out of contact with the thermal head 32 with the swinging motion of the platen holder 37.

The convey roller 34 is arranged to the left of the platen roller 33. The convey roller 34 comes into and out of contact with the drive roller 101 of the tape cassette 100 with the swinging motion of the platen holder 37. The platen holder 37 swings between the separated position and the printing position in conjunction with the opening and closing of the main cover 40.

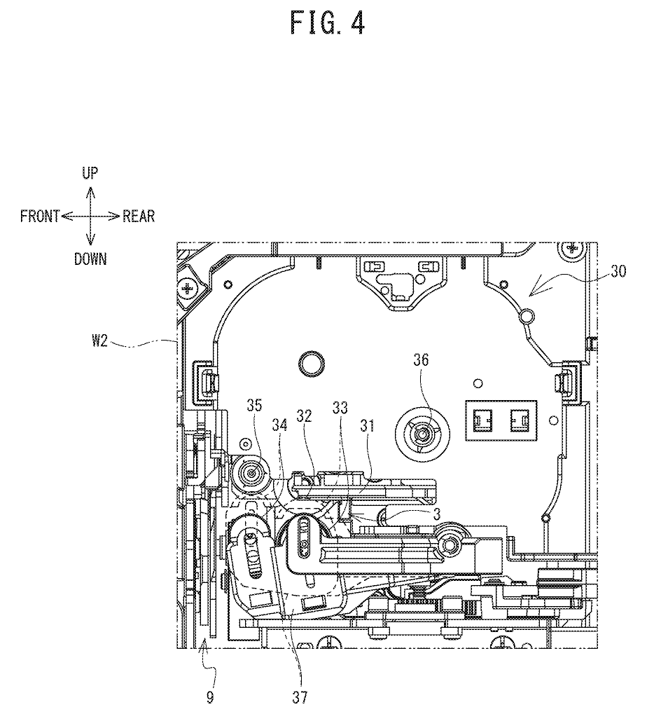

When the main cover 40 is opened, the platen holder 37 moves to the separated position. The separated position is a position where the platen roller 33 and the convey roller 34 are separated from the compartment 30, which is indicated by a solid line in FIG. 4. While the platen holder 37 is in the separated position, the user can install the tape cassette 100 into, or remove the tape cassette 100 from, the compartment 30. That is, in conjunction with the opening operation of the main cover 40, the tape 150, which is held pinched at the nip portion between the drive roller 101 and the convey roller 34, is released.

When the main cover 40 is closed, the platen holder 37 moves to the printing position. The printing position is defined as the location where the platen roller 33 and the convey roller 34 are positioned near the compartment 30, as indicated by the dotted line in FIG. 4. In the printing position, the platen roller 33 presses the film tape 110 and the ink ribbon 130 against the thermal head 32. At the printing position, the convey roller 34 overlays the film tape 110 with the double-sided adhesive tape 120, pinches them at the nip portion, and presses them against the drive roller 101. That is, in conjunction with the closing operation of the main cover 40, the tape 150 is held in a conveyable state by being pinched at the nip portion between the drive roller 101 and the convey roller 34.

The tape cassette 100 receives the film tape 110, the double-sided adhesive tape 120, and the ink ribbon 130 in a box-shaped case. Within the tape cassette 100, the film tape 110, the double-sided adhesive tape 120, and the ink ribbon 130 are each wound around their respective corresponding spools. An arm portion 102 is located at the lower portion of the case. The arm portion 102 extends from the lower rear portion of the case to the lower front portion. The film tape 110 and the ink ribbon 130 are pulled out of the case through an opening located at the left end of the arm portion 102 and are overlaid upon each other.

A head insertion portion 104 is located above the arm portion 102. The head insertion portion 104 passes through the case in the up-down direction. In a state where the tape cassette 100 is installed in the compartment 30, the head holder 31 is inserted into the head insertion portion 104.

The drive roller 101 is positioned in front of the head insertion portion 104. The drive roller 101 is cylindrical and extends in the left-right direction. The lower end portion of the drive roller 101 is exposed downward from the case.

The drive roller 101 supports the double-sided adhesive tape 120 in a state in which the film tape 110 and the double-sided adhesive tape 120 are overlaid with each other. In the state in which the tape cassette 100 is installed in the compartment 30, the drive shaft 35 is inserted into the shaft hole of the drive roller 101. The drive roller 101 rotates by the rotational driving of the drive shaft 35. The drive roller 101 conveys the film tape 110 and the double-sided adhesive tape 120 in a state pinched between the drive roller 101 and the convey roller 34. That is, the tape 150 is conveyed by being fed out from the nip portion formed between the drive roller 101 and the convey roller 34, by the driving of the drive roller 101.

A guide portion 106 is located at a corner portion diagonally downward and at the front of the case. The guide portion 106 is located to the left of the drive roller 101. The guide portion 106 is situated downstream of the drive roller 101 in the convey direction of the film tape 110.

The guide portion 106 has a slit shape that extends in the left-right direction. The tape 150, in which the double-sided adhesive tape 120 is affixed to the film tape 110, is conveyed to the drive roller 101 and passes through the guide portion 106. The guide portion 106 supports the tape 150 from both sides in the width direction. The tape 150 is ejected from the tape cassette 100 in a state in which the posture of the tape 150 maintained by the support of the guide portion 106.

During printing in the print mechanism 3, the platen holder 37 moves from the separated position to the printing position. The platen roller 33 presses the film tape 110 and the ink ribbon 130 in the overlaid state against the thermal head 32. The platen roller 33 rotates and conveys the film tape 110 toward the front.

At the same time the film tape 110 is being conveyed, the thermal head 32 generates heat and the ink ribbon 130 is heated. The ink of the ink ribbon 130 is transferred onto the print surface of the film tape 110 due to the ink ribbon 130 being heated. The print surface of the film tape 110 is the surface that faces the thermal head 32 within the case, that is, the surface facing upward. By the transfer of ink, images including characters, for example, are printed onto the film tape 110. After printing, the ink ribbon 130 separates from the film tape 110 and is wound up by the winding spool 132.

The double-sided adhesive tape 120 is overlaid with the print surface of the printed film tape 110. The base material of the double-sided adhesive tape 120 comes into contact with the print surface of the film tape 110. The film tape 110 and the double-sided adhesive tape 120 pass between the drive roller 101 and the convey roller 34 in a state where the film tape 110 is disposed beneath the double-sided adhesive tape 120. As a result of the film tape 110 being affixed to the base material by adhesive, the printed label 160 is produced.

The upper surface of the label 160 corresponds to the adhesive surface of the base material to which the adhesive is applied, and the release material 170 is affixed to the adhesive surface. That is, as a result of the double-sided adhesive tape 120 being affixed to the film tape 110, the tape 150 is produced in a state where the release material 170 is affixed to the label 160. The width direction of the tape 150 corresponds to the left-right direction. The convey path of the tape 150, which is conveyed from the print mechanism 3 through the cutting portion 9 to the peeling portion 4, will be referred to as a convey path R1.

### Cutting portion 9

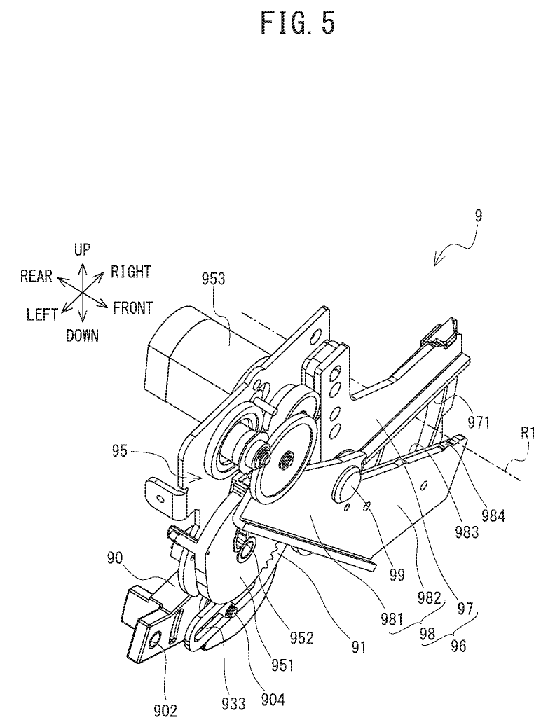

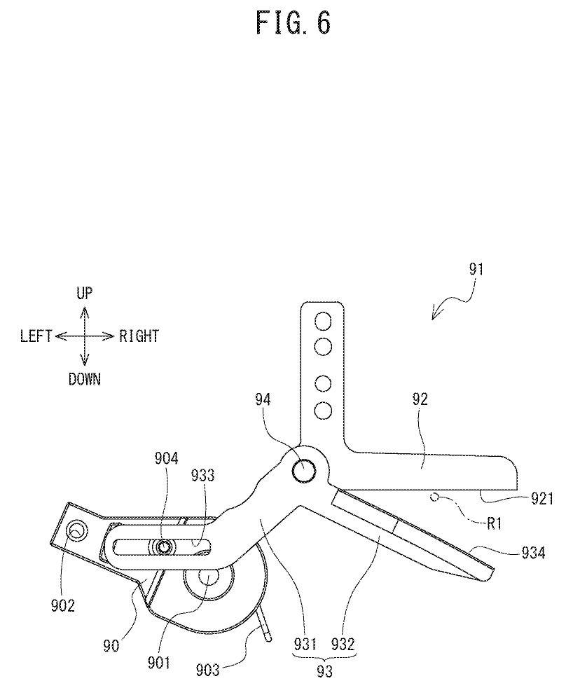

The cutting portion 9 is disposed downstream of the convey roller 34 in the convey direction of the tape 150. As shown in FIGS. 5 and 6, the cutting portion 9 includes a full-cut cutting blade 91 and a half-cut cutting blade 96. The full-cut cutting blade 91 includes a fixed blade 92, which is fixed above the convey path R1, and a movable blade 93, which is rotatable below the convey path R1. The fixed blade 92 extends in the left-right direction and has a cutting edge 921 facing downward.

The movable blade 93 has a plate shape extending bent, and is rotatably supported by a rotation shaft 94. The rotation shaft 94 is located to the left of the convey path R1and extends in the front-rear direction. The movable blade 93 includes a left end portion 931 that extends bent toward the left of the rotation shaft 94, and a right end portion 932 that extends straight toward the right of the rotation shaft 94. The left end portion 931 includes a long hole 933. The right end portion 932 faces toward the right with a cutting edge 934 extending in the left-right direction facing upward.

The cutting portion 9 includes a connecting portion 90 located to the left of the convey path R1 and to the rear of the full-cut cutting blade 91. The connecting portion 90 extends in the left-right direction, with a right end portion thereof being rotatably supported by a rotation shaft 901. The rotation shaft 901 is located diagonally downward to the left of the rotation shaft 94, and extends in the front-rear direction.

A torsion spring 903 is located around the rotation shaft 901 on the rear surface of the connecting portion 90. The torsion spring 903 biases the connecting portion 90 in the clockwise direction with the rotation shaft 901 as the fulcrum when viewed from the front. A connecting hole 902 is formed in the left end portion of the connecting portion 90. An interlocking bar engages with the connecting hole 902. A pin 904, which engages with the long hole 933 of the movable blade 93, is located between the rotation shaft 901 of the connecting portion 90 and the connecting portion 90 itself.

As shown in FIG. 2, an operation lever 18 is disposed below the compartment 30 on the right surface of the housing 10. The operation lever 18 is operated by a user and slides in the left-right direction. The operation lever 18 is positioned so as to be covered by the right wall 385 of the main cover 40 at the second cover portion 42 when the main cover 40 is in the closed state. That is, the operation lever 18 becomes operable by the user when the main cover 40 is in the open state. The operation lever 18 is connected to the interlocking bar and operates in conjunction with the full-cut cutting blade 91.

As shown in FIG. 6, when the movable blade 93 of the full-cut cutting blade 91 is in the stand-by position, the connecting portion 90 is at the position rotated to the maximum in the clockwise direction, as viewed from the front, with the rotation shaft 901 as the fulcrum. The pin 904 of the connecting portion 90 is positioned at an intermediate part of the long hole 933 in the movable blade 93.

When the operation lever 18 is pressed and slid rearward by the user, the connecting hole 902 of the connecting portion 90 moves downward by the interlocking bar. The connecting portion 90 rotates counterclockwise, when viewed from the front, with the rotation shaft 901 as the fulcrum. The pin 904 moves downward, thereby pressing the long hole 933 down. The movable blade 93 rotates counterclockwise, when viewed from the front, with the rotation shaft 94 as the fulcrum, and moves to the cutting position. The cutting position is a position where, when viewed front the front, the movable blade 93 rotates counterclockwise from the stand-by position, and the cutting edge 934 of the right end portion 932 intersects with the cutting edge 921 of the fixed blade 92.

When the operation lever 18 is not slid rearward, the connecting portion 90 moves to the stand-by position due to the urging force of the torsion spring 903. The stand-by position is a position where, when viewed from the front, the movable blade 93 is rotated in the clockwise direction from the cutting position so that the cutting edge 934 of the right end portion 932 is retracted to a position below the convey path R1. The full-cut cutting blade 91 moves the cutting edge 934 of the movable blade 93 across the convey path R1 from below the convey path R1 to above the convey path R1 with respect to the cutting edge 921 of the fixed blade 92. The movable blade 93 fully cuts the tape 150 conveyed along the convey path R1. That is, the tape 150 is cut by being pinched between the fixed blade 92 and the movable blade 93.

As shown in FIG. 5, the half-cut cutting blade 96 is disposed downstream, that is, in front, of the full-cut cutting blade 91 along the convey path R1. The half-cut cutting blade 96 includes a fixed base 97 fixed above the convey path R1, and a movable blade 98 that is rotatable below the convey path R1. The fixed base 97 extends in the left-right direction and includes a blade contact surface 971 facing downward, i.e., toward the convey path R1. The movable blade 98 has a plate shape that extends in the left-right direction, and is supported by a rotation shaft 99. The rotation shaft 99 is disposed to the left of the convey path R1 and extends in the front-rear direction.

The movable blade 98 includes a left end portion 981 that extends straight toward the left of the rotation shaft 99, and a right end portion 982 that extends straight toward the right of the rotation shaft 99. The left end portion 981 includes, on an end portion thereof, a pin projecting toward the rear. The right end portion 982 faces upward, thereby orienting the cutting edge 983, which extends left-right direction, upward. On an end portion of the right end portion 982, a protrusion 984 is formed that protrudes slightly above the cutting edge 983. The height by which the protrusion 984 protrudes upward above the cutting edge 983 is approximately equal to the thickness of the release material 170.

The cutting portion 9 includes a transmission unit 95 that is positioned to the left of the convey path R1 and to the rear of the half-cut cutting blade 96, and which transmits the driving force of a cutting motor 953 to the movable blade 98. The transmission unit 95 has a plurality of gear sets, and the drive shaft of the cutting motor 953 meshes with the uppermost gear. A lowermost drive gear 951 of the transmission unit 95 has a long groove 952 with which the pin at the left end portion 981 of the movable blade 98 engages. The long groove 952 extends from near the rotation center of the drive gear 951 toward the outer periphery of the drive gear 951.

The cutting motor 953 rotates the drive gear 951, and moves the pin along the long groove 952, thereby moving the movable blade 98 between the cutting position and the stand-by position. The cutting position is a position in which the movable blade 98 rotates counterclockwise from the stand-by position in a front view, and the protrusion 984 on the right end portion 982 abuts against the blade contact surface 971 of the fixed base 97. In this case, a gap equal to the thickness of the release material 170 is formed between the cutting edge 983 of the movable blade 98 and the blade contact surface 971. The stand-by position is a position in which the movable blade 98 rotates in the clockwise direction from the cutting position in a front view, and the cutting edge 983 of the right end portion 982 retracts below the convey path R1.

The half-cut cutting blade 96 is such that a gap equal to the thickness of the release material 170 is formed between the cutting edge 983 and the blade contact surface 971 due to the protrusion 984. The movable blade 98 performs a half-cut on the label 160 of the tape 150 conveyed along the convey path R1. That is, the label 160 of the tape 150 is cut, while the release material 170 remains uncut.

### Main Unit 2

As shown in FIG. 3, the main unit 2 includes a base body 20 that supports the entirety of the unit. The base body 20 is made of resin, and both surfaces are reinforced by metal plates. The base body 20 includes the peeling portion 4, the pressing portion 25, the opening/closing portion 6, and the wrapping portion 7.

The bottom portion of the base body 20 is fixed at a position toward the front right of the base 11. The wrapping portion 7 for wrapping the label 160 around the cable 19 is disposed in the bottom portion. A semi-cylindrical housing portion 211 is located in the bottom portion. A rotation body 70 of the wrapping portion 7 is received within the housing portion 211.

The middle portion of the base body 20 is located above the bottom portion. A peeling region where the label 160 is peeled away is located in the middle portion. The peeling portion 4, the pressing portion 25, and the opening/closing portion 6 are all located in the peeling region. The upper portion of the base body 20 is located above the middle portion. A first convey guide 231 and a second convey guide 236 are disposed in the upper portion.

The first convey guide 231 has a plate shape and extends diagonally upwards toward the front when viewed from the side. The first convey guide 231 guides the tape 150 along the convey path R1 to the peeling portion 4. The second convey guide 236 has a plate shape and extends diagonally upward toward the rear from the front end of the first convey guide 231 when viewed from the side. The second convey guide 236 guides the release material 170, from which the label 160 has been peeled off at the peeling portion 4, along a convey path R2 to the winding portion 8. The convey path for the release material 170 conveyed from the peeling portion 4 to the winding portion 8 will be referred to as the convey path R2.

Peeling region

The peeling portion 4 is located at a connecting portion of the first convey guide 231 and the second convey guide 236. The peeling portion 4 has a round rod shape that extends in the left-right direction. The surface of the peeling portion 4 includes a coating layer that inhibits the adhesive from adhering when the label 160 is peeled from the release material 170. The convey pathR1 and the convey path R2 bend sharply at the peeling portion 4. The peeling portion 4 peels the label 160 away from the release material 170 by tension generated by the winding portion 8 winding up the release material 170.

The opening/closing portion 6 has box shape that extends in the up-down direction, and is disposed at the front portion of the base body 20. The upper portion of the opening/closing portion 6 swings in the front-rear direction with a shaft extending in the left-right direction at the lower end portion of the opening/closing portion 6 as the fulcrum. The housing portion 211 of the wrapping portion 7 is opened and closed by the swinging of the opening/closing portion 6.

The opening/closing portion 6 has a pressing portion 60 on a rear surface in the closed state. The pressing portion 60 includes a pressing surface 61 that extends in the up-down direction and faces toward the rear. When the user moves the cable 19 from the peeling portion 4 toward the wrapping portion 7, the cable 19 is guided by a guide surface 21 and passes downward between the guide surface 21 and the pressing surface 61. The guide surface 21 is disposed at two locations, i.e., the left portion and the right portion of the peeling region, extends in the up-down direction, and faces forward.

The user grips the cable 19, which extends in the left-right direction, with both hands and brings the cable 19 into contact with the guide surface 21. The guide surface 21 guides the cable 19, with the label 160 that was peeled off by the peeling portion 4 affixed thereto, to the wrapping portion 7. The user moves the cable 19 downward along the guide surface 21 toward the wrapping portion 7 situated below the peeling portion 4. When passing between the guide surface 21 and the pressing surface 61, the end portion of the label 160 is pressed against the cable 19 by the pressing surface 61.

The pressing portion 25 is a member that presses the end portion of the label 160 against the cable 19. The pressing portion 25 is a member that is arranged below the first convey guide 231 and has a plate shape with a rear end portion that is pivotally supported. A tip end portion of the pressing portion 25 is exposed between the guide surface 21 and the pressing surface 61. The pressing portion 25 is urged by a torsion spring such that its tip end portion is positioned above its rear end portion.

When the user moves the cable 19 downward along the guide surface 21, the pressing portion 25 sandwiches an end portion of the label 160 between the tip end portion of the pressing portion 25 and the cable 19. The pressing portion 25 is rotated by being pressed by the cable 19, thereby moving the tip end portion of the pressing portion 25 downward. The pressing portion 25 rotates while maintaining a state in which the end portion of the label 160 is pressed against the cable 19, so as to prevent the end portion of the label 160 from peeling off.

### Wrapping portion 7

The wrapping portion 7 winds and affixes the label 160, an end portion of which adheres to the cable 19 that is guided by the guide surface 21, around the cable 19. The wrapping portion 7 includes the approximately cylindrical rotation body 70 having a side surface that is partially missing. A rotation shaft 70A of the rotation body 70 extends in the left-right direction. The rotation body 70 is rotatably supported by support members 72 fixed to the left and right sides, respectively, of the base body 20. The rotation body 70 is rotationally driven by a wrapping motor.

The rotation body 70 houses arm portions 76 and 77 therein and supports the arm portions 76 and 77 so as to enable the arm portions 76 and 77 to swing. The arm portions 76 and 77 pinch and hold the cable 19 when the label 160 is wrapped around the cable 19. When the rotation body 70 rotates, the arm portions 76 and 77 rotate around the cable 19 and wrap the label 160 around the outer peripheral surface of the cable 19. The label 160 that has been wrapped around the outer circumferential surface of the cable 19 is affixed to the cable 19 by means of an adhesive material.

### Winding portion 8

The winding portion 8 is positioned diagonally above and to the rear of the peeling portion 4. The winding portion 8 is arranged on the right surface of the main plate, above the front upper corner portion of the compartment 30. The winding portion 8 winds the release material 170 into a roll, thereby applying to the tape 150 the tension necessary for feeding the tape 150 and peeling off the label 160.

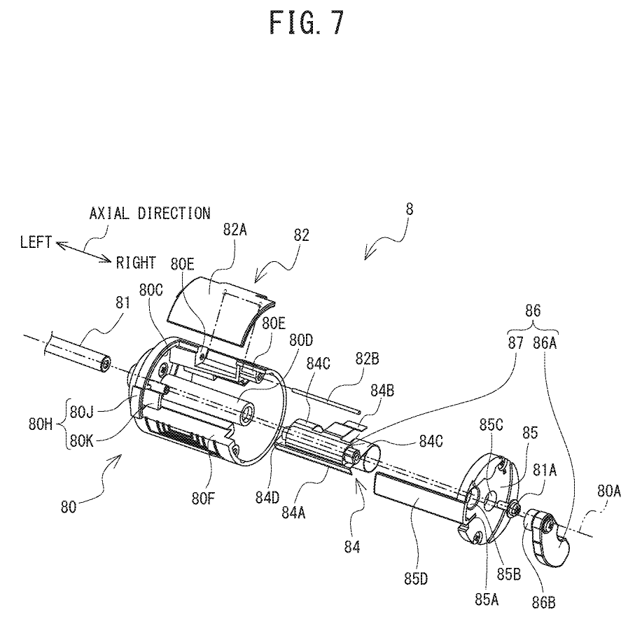

As shown in FIGS. 2, 3, and 7, the winding portion 8 includes the reel 80, a shaft 81, an advancing/retracting member 82, a presser member 84, a lid member 85, and an operation member 86. The reel 80 has a cylindrical shape, with a rotational axis center 80A of the reel 80 extending in the left-right direction. The left surface of the reel 80 is closed and has an opening at the center into which the shaft 81 is inserted. The opening of the shaft 81 is connected to the inner peripheral surface of a tubular shaft 80D, which extends in a tubular shape within the reel 80 from the left surface toward the right. The shaft 81 is fastened to the right end of the tubular shaft 80D by a screw 81A, and is thereby fixed to the reel 80.

The shaft 81 extends toward the right from the right surface of the main plate, which is fixed to the housing 10. The shaft 81 is connected to the winding motor via a plurality of gears arranged in the drive unit on the right surface of the main plate. The plurality of gears transmit the driving force of the winding motor to the shaft 81. The reel 80 rotates in response to the driving of the winding motor controlled by the control unit.

The driving force of the winding motor is transmitted to the shaft 81 via the plurality of gears, thereby driving the reel 80 to rotate counterclockwise when viewed from the right. The length of the reel 80 in the left-right direction is greater than the maximum width of the tape 150 compatible with the label affixing device 1. The right end portion of the reel 80 is open. The release material 170 is wound into a roll on the outer peripheral surface of the reel 80.

The right surface of the reel 80 is open. The reel 80 includes an opening 80C that extends through an outer peripheral surface 80B of the reel 80. The opening 80C is open on the right surface. One circumferential end portion of the opening 80C constitutes a slot 80F.

The plate-shaped advancing/retracting member 82 and a long plate-shaped spacer member 85D are disposed in the opening 80C. The advancing/retracting member 82 is positioned near the other end, opposite to the slot 80F in the circumferential direction. The advancing/retracting member 82 includes an outer surface 82A that is curved along the outer peripheral surface 80B of the reel 80. The advancing/retracting member 82 has, at the other end in the circumferential direction on the outer surface 82A, a shaft hole through which a shaft 82B extending in the axial direction is inserted.

The shaft 82B is retained by a bearing 80E inside the reel 80 at the other end in the circumferential direction of the opening 80C of the reel 80. Accordingly, the advancing/retracting member 82 swings about the shaft 82B, with the other end in the circumferential direction of the outer surface 82A serving as a free end.

The spacer member 85D extends in the left-right direction, with a right end portion of the spacer member 85D arranged at the peripheral edge portion of the lid member 85, described later, and is formed integrally with the lid member 85. The spacer member 85D is disposed in the opening 80C, in the gap between the slot 80F and the advancing/retracting member 82. The left end portion of the spacer member 85D engages with an engagement portion 80H arranged at the left end portion of the reel 80. The engagement portion 80H has an outer engagement portion 80J disposed to the outside of the outer peripheral surface 80B of the reel 80, and an inner engagement portion 80K disposed to the inside of the inner peripheral surface of the reel 80.

A gap exists in the radial direction between the outer engagement portion 80J and the inner engagement portion 80K. The left end portion of the spacer member 85D is inserted into and positioned in the gap between the outer engagement portion 80J and the inner engagement portion 80K. The outer surface of the spacer member 85D is curved circumferentially along the outer peripheral surface 80B of the reel 80. The outer surface of the spacer member 85D is positioned, in the radial direction, at substantially the same location as the outer peripheral surface 80B of the reel 80. One end surface of the spacer member 85D in the circumferential direction is arranged so as to face the slot 80F, and constitutes an insertion opening for inserting the end portion of the release material 170.

The reel 80 has the slot 80F on the outer peripheral surface 80B at the other end in the circumferential direction from the opening 80C. The slot 80F has a slit shape and extends in the axial direction. The inner wall of the slot 80F extends toward substantially the center, in the radial direction, in the reel 80. The end portion of the release material 170 wound by the winding portion 8 is inserted into the slot 80F.

The presser member 84 is a metal leaf spring. One end portion of the presser member 84 in a direction orthogonal to the axial direction is bent, and at the edge portion of the one end portion, a presser portion 84A having a plurality of teeth arranged in the axial direction is present. A support portion 84C and a restricting portion 84B are formed at the other end of the presser member 84. The support portion 84C is bent in a cylindrical shape with a curvature larger than the outer diameter of the tubular shaft 80D. The support portion 84C engages with the outer circumferential surface of the tubular shaft 80D, and rotatably supports the presser member 84 about the tubular shaft 80D.

The restricting portion 84B catches on a catch portion 80G within the reel 80. The restricting portion 84B restricts rotation of the presser member 84 in the counterclockwise direction when viewed from the right. A flexible portion 84D is a portion located between the support portion 84C and the presser portion 84A. The flexible portion 84D bends under the pressure applied by a cam member 87. The flexible portion 84D returns to its original state by elastic force when the pressure is released.

The lid member 85 has a disc shape and closes off the right surface of the reel 80. The lid member 85 is arranged inside the right end portion of the reel 80 and is fastened with screws. The spacer member 85D is integrally formed on the side surface of the lid member 85, and extends to the left.

A screw hole 85C extends through the center of the lid member 85 in the left-right direction. The screw 81A for securing the reel 80 to the shaft 81 is inserted into the screw hole 85C and secures the tubular shaft 80D of the reel 80 to the shaft 81. Accordingly, by loosening the screw 81A, the reel 80 can be removed to the right from the shaft 81, thereby enabling maintenance to be performed.

The lid member 85 includes a removal opening 85A having a long thin cutout shape. The removal opening 85A is positioned at a location corresponding to the opening on the right surface of the slot 80F, and is connected to the slot 80F. From a state in which the end portion of the release material 170 is inserted in the slot 80F, the end portion of the release material 170 can be removed from the removal opening 85A by sliding the end portion of the release material 170 to the right.

The operation member 86 moves the free end of the advancing/retracting member 82 and the presser portion 84A of the presser member 84. The operation member 86 has an operation portion 86A and the cam member 87. A rotation shaft 86B of the operation portion 86A is rotatably supported in a support hole 85B of the lid member 85.

The operation portion 86A is disposed on the right surface of the lid member 85. The operation portion 86A rotates between a first position and a second position along the right surface of the lid member 85. The cam member 87 is disposed inside the reel 80. The cam member 87 is connected to the rotation shaft 86B of the operation portion 86A. Accordingly, the cam member 87 rotates in response to the rotation of the operation portion 86A.

When the operation portion 86A is in the first position, the cam member 87 pushes the free end of the advancing/retracting member 82 outward in the radial direction. As a result, the outer surface 82A of the advancing/retracting member 82 is disposed substantially at the same position as the outer peripheral surface 80B of the reel 80 in the radial direction. Furthermore, when the operation portion 86A is in the first position, the cam member 87 presses on the flexible portion 84D. As the flexible portion 84D bends, the presser portion 84A comes into contact with the slot 80F of the reel 80. When the end portion of the release material 170 is inserted into the slot 80F, the presser portion 84A can hold the end portion of the release material 170 in the slot 80F.

When the operation portion 86A is in the second position, the cam member 87 releases the pressure applied to the free end of the advancing/retracting member 82. As a result, the outer surface 82A of the advancing/retracting member 82 is disposed radially inward relative to the position of the outer peripheral surface 80B of the reel 80 in the radial direction. In addition, when the operation portion 86A is in the second position, the cam member 87 releases the pressure applied to the flexible portion 84D. When the flexible portion 84D returns to its original state by elastic force, a gap is formed between the presser portion 84A and the slot 80F of the reel 80. The presser portion 84A is capable of releasing the end portion of the release material 170 that is held in the slot 80F.

### Operation of label affixing device 1

In the label affixing device 1, the tape 150 is pulled out of the tape cassette 100 in advance and is arranged along the first convey guide 231 and the second convey guide 236. The end portion of the tape 150 is inserted into the slot 80F of the reel 80 of the winding portion 8. By positioning the operation portion 86A at the first position, the end portion of the tape 150 is held by the presser member 84.

During printing, the user operates an external device such as a PC to create print data for label printing, and transmits a print command to the label affixing device 1. The control unit prints an image onto the print surface of the film tape 110 while conveying the tape 150 toward the cutting portion 9 by driving the convey motor. Furthermore, a CPU 51 rotates the reel 80 by driving the winding motor to wind the release material 170. Note that when printing immediately after the tape 150 is held by the reel 80, because the label 160 is not yet separated from the release material 170, the tape 150 is wound onto the reel 80.

The label 160 on which the image has been printed is half-cut at the cutting portion 9 and then conveyed toward the peeling portion 4 in a separable state. The tension necessary for separating the label 160 is applied to the tape 150 by winding the release material 170 with the reel 80 of the winding portion 8.

With the tension necessary for peeling applied, the tape 150 is sharply bent at the peeling portion 4, separating the end portion of the image-printed label 160 from the release material 170. The driving of the winding motor and the convey motor is stopped. The end portion of the label 160 is arranged at the peeling portion 4 with the adhesive surface facing upward.

The user affixes the end portion of the label 160 to the cable 19 at the peeling portion 4, moves the cable 19 downward along the guide surface 21, and inserts the end portion of the label 160 into the wrapping portion 7. As the cable 19 moves downward, the unpeeled portion of the label 160 is separated from the release material 170. When the switch for detecting the cable 19 is turned on, the rotation body 70 is rotated by driving the wrapping motor. The label 160 is wrapped around the outer peripheral surface of the cable 19 and affixed to the cable 19 with an adhesive.

### Replacement of Tape Cassette 100

The release material 170 is wound in a roll around the outer peripheral surface of the reel 80. During winding, the outer surface 82A of the advancing/retracting member 82 is disposed at the same position as the outer peripheral surface 80B of the reel 80. Accordingly, the inner diameter of the release material roll 175, in which the release material 170 is wound in a roll, becomes approximately the same as the outer diameter of the reel 80.

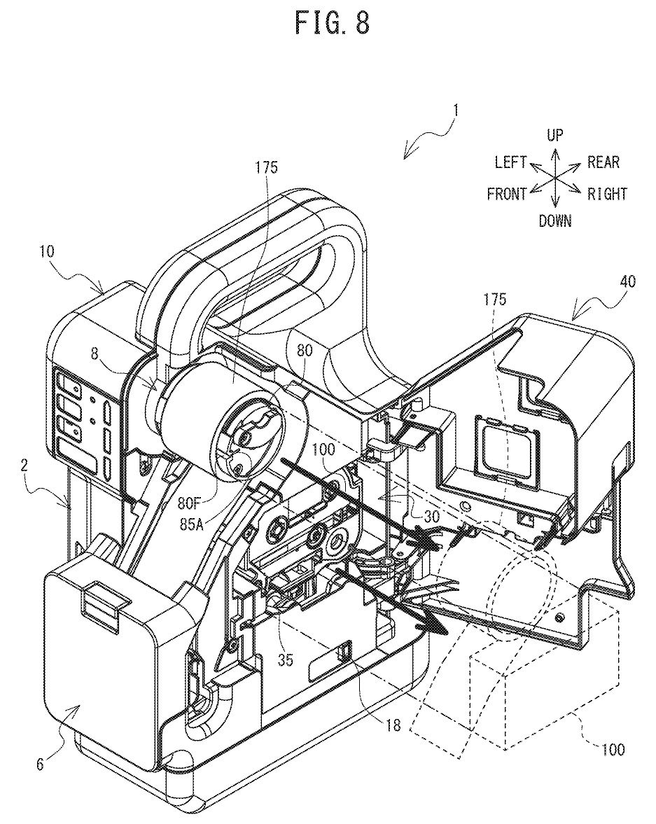

As shown in FIG. 8, when replacing the tape cassette 100, the user opens the main cover 40. The main cover 40 moves from a position to the right of the reel 80 and the compartment 30 to a position where it is not to the right. Accordingly, the reel 80 and the compartment 30 are exposed on the right.

The user slides the operation lever 18 backward to cut the tape 150 using the full-cut cutting blade 91. The release material roll 175 is separated from the tape cassette 100. The user moves the operation portion 86A of the reel 80 from the first position to the second position. The outer surface 82A of the advancing/retracting member 82 is disposed radially inward of the outer peripheral surface 80B of the reel 80. As a result, the difference between the inner diameter of the release material roll 175 and the outer diameter of the reel 80 increases.

Further, the end portion of the release material 170 inserted into the slot 80F is released from being held by the presser portion 84A. Furthermore, the removal opening 85A of the lid member 85 is uncovered from the operation portion 86A as the operation portion 86A moves from the first position to the second position.

The user pulls the cut portion of the tape 150 and removes the release material roll 175 from the reel 80. The direction for removing the reel 80 is to the right, which is the direction in which there is no main plate fixing the shaft 81, in the left-right direction in which the rotational axis center 80A of the reel 80 extends. The user can move the end portion of the release material roll 175 to the right within the slot 80F, and remove the release material roll 175 to the right of the reel 80 through the removal opening 85A that is connected to the slot 80F. The user further removes, from the compartment 30, the tape cassette 100 from which the release material roll 175 has been detached. The direction in which the tape cassette 100 is removed is to the right, which is the direction in which the compartment 30 opens, in the left-right direction along which the rotational axis center of the drive shaft 35 disposed in the compartment 30 extends.

That is, the user can open the main cover 40 from the right of the housing 10 and operate the operation lever 18 of the cutting portion 9 from the right. Furthermore, the user can remove the release material roll 175 from the reel 80 and also remove the tape cassette 100 from the compartment 30 from the right of the housing 10. In addition, the user can install the replaced tape cassette 100 in the compartment 30 from the right of the housing 10.

### Operation and Effects

As described above, when the tape 150 is depleted or is replaced in the middle of use, the tape 150 is removed from the compartment 30. In addition, the release material roll 175 around which the release material 170 is wound is also removed from the reel 80. Both the direction in which the release material roll 175 is removed from the reel 80 and the direction in which the tape 150 is removed from the compartment 30 are towards the right, i.e., the same direction. Accordingly, the user is able to perform both the operation of removing the tape 150 from the compartment 30 and the operation of removing the release material roll 175 from the reel 80 from the same side relative to the housing 10. Therefore, the label affixing device 1 can reduce the work involved in replacing the tape 150.

When replacing the tape 150, opening the main cover 40 causes both the first cover portion 41, which covers the reel 80, and the second cover portion 42, which covers the compartment 30, to open together. Accordingly, by opening the main cover 40, the user can perform both the operation of removing the tape 150 and the operation of removing the release material roll 175 from the label affixing device 1 from the same direction.

The release material 170 from which the label 160 has been separated from the tape 150 is wound onto the winding portion 8 without being cut. When removing the tape 150 from the compartment 30, the full-cut cutting blade 91 of the cutting portion 9 can manually cut the tape 150 by operating the operation lever 18. When removing the release material roll 175 from the reel 80, the cut tape 150 is wound onto the release material roll 175. As a result, the cut tape 150 can be removed together with the release material roll 175, separately from the tape 150 remaining on the compartment 30. Therefore, the user can easily perform the operation of removing the release material roll 175 from the reel 80. Moreover, by configuring the full-cut cutting blade 91 of the cutting portion 9 to be operated manually, the label affixing device 1 can reduce the number of components and lower the cost.

The operation lever 18 is positioned in a location that is covered by the second cover portion 42 of the main cover 40 when the second cover portion 42 is closed. When cutting the tape 150, the user opens the second cover portion 42 and operates the operation lever 18. The tape 150 is cut when the tape 150 remaining in the compartment 30 is removed. That is, when the second cover portion 42 is closed, the user is unable to operate the operation lever 18. Accordingly, the label affixing device 1 can prevent the tape 150 from being cut due to erroneous operation by the user.

When the main cover 40 is opened, the nip portion between the convey roller 34 and the drive roller 101 is released, thereby preventing the tape 150 from being conveyed. The full-cut cutting blade 91 of the cutting portion 9 is operated in a state where the second cover portion 42 is open. That is, the full-cut cutting blade 91 does not operate while the tape 150 is being conveyed. Accordingly, with the label affixing device 1, a sensor for detecting an operational state that ensures the full-cut cutting blade 91 does not operate while the tape 150 is being conveyed can be omitted.

The reel 80 can be removed from the shaft 81. Therefore, the reel 80 is replaceable. Furthermore, when removing the release material roll 175, the reel 80 together with the release material roll 175 can be removed from the shaft 81, thereby facilitating the removal of the release material roll 175. After the user removes the release material roll 175 from the reel 80, the reel 80 can be easily reattached to the shaft 81, thus restoring the reel 80 to its original state. Accordingly, the release material roll 175 is easily detachable from the reel 80.

The spacer member 85D protruding from the lid member 85 constitutes a part of the outer peripheral surface 80B of the reel 80. The left end portion of the spacer member 85D engages with the engagement portion 80H of the reel 80. Accordingly, even if the spacer member 85D is pressed from the outside toward the inside of the reel 80 when the release material 170 is wound, the spacer member 85D is less likely to bend toward the inside of the reel 80. Furthermore, because the engagement portion 80H is located at the left end portion of the reel 80, when the release material roll 175 is removed to the right from the reel 80, the release material roll 175 will not become caught on the engagement portion 80H.

The removal opening 85A of the lid member 85 of the reel 80 is connected to the slot 80F of the reel 80. Therefore, when removing the release material roll 175 from the reel 80, the user can slide the end portion of the release material 170 to the right and remove the end portion of the release material 170 from the removal opening 85A, without having to pull the end portion of the release material 170 out of the slot 80F. Therefore, the user can easily remove the release material roll 175.

The tape cassette 100 houses the tape 150. By performing the operation of installing and removing the tape 150 into and from the compartment 30 as the operation of installing and removing the tape cassette 100, the operation becomes easier. Accordingly, the label affixing device 1 can reduce the work involved in replacing the tape 150.

### Others

In the above-described embodiment, the tape 150 is one example of the medium of the present disclosure. The thermal head 32 and the platen roller 33 are one example of the print portion of the present disclosure. The drive shaft 35 and the convey roller 34 are one example of the convey portion of the present disclosure. The cable 19 is one example of the rod-shaped member in the present disclosure.

The shaft 81 is one example of the reel shaft of the present disclosure. The release material roll 175 is one example of the roll of the present disclosure. The right direction is one example of the first direction and the second direction of the present disclosure. The main cover 40 is one example of the cover of the present disclosure. The operation lever 18 is one example of the lever of the present disclosure.

The left direction is one example of the third direction of the present disclosure. The opening 80C is one example of the opening of the present disclosure. The reel 80 is one example of the main body portion of the present disclosure. The lid member 85 is one example of the cover portion of the present disclosure. The spacer member 85D is one example of the protrusion of the present disclosure. The left end portion of the spacer member 85D is one example of the tip end portion of the present disclosure.

The tape cassette 100 is one example of the cassette of the present disclosure.

### Modified examples

The present disclosure is not limited to the above-described embodiment; various modifications are possible. The printing method employed by the print mechanism 3 is not limited to the above-described embodiment. For example, the label affixing device 1 may perform printing using a receptor-type tape cassette. The receptor-type tape cassette houses a tape, in which a base material and a release material that is adhered to the adhesive surface of the base material to which an adhesive has been applied are laminated together, as well as an ink ribbon. The print mechanism 3 performs printing on the surface of the tape opposite to the adhesive surface.

It should be noted that label 160 may be a standard label, or may be of indefinite length as in the present embodiment. When the standard label 160 is used, the tape 150 may be configured such that, for example, die-cut labels pre-cut to a predetermined size are affixed to the release material 170 as the base material. In this case, the label affixing device 1 need not be provided with the half-cut cutting blade 96.

The label affixing device 1 need not be equipped with the print mechanism 3. In this case, the label affixing device 1 may peel off a label on which an image has been printed in advance from the release material and affix the label to the cable 19 by wrapping the label around the cable 19. Further, the printing on tape 150 may also be performed by an external printer.

The object to which the label 160 is affixed is not limited to the cable 19, and may be another adherend. For example, the label 160 may be affixed to stationery such as pens or to tools such as screwdrivers. Furthermore, the adhesive surface of the tape 150 is not limited to one with an applied adhesive; adhesiveness may also be obtained by processing.

The operation method for the operation lever 18 is not limited to sliding in the left-right direction; various methods such as rotational operation of a knob, vertical movement of a lever, or depression of a button, may also be employed. When removing the reel 80 from the shaft 81, the method of removal is not limited to loosening a screw; removal may also be achieved by disengaging hooks or the like, or by removing both the reel 80 and the shaft 81 together from the drive unit. The tape 150 is housed in the tape cassette 100 and the entire tape cassette 100 is installed in the compartment 30. The disclosure is not limited to this; a roll with tape 150 wound thereon may also be installed in the compartment 30.

Although the nip portion between the drive roller 101 and the convey roller 34 is opened in conjunction with the opening operation of the main cover 40, the opening of the nip portion does not necessarily need to be linked to the main cover 40. The full-cut cutting blade 91 is not essential; the user may cut the release material 170 with scissors when replacing the tape 150. The operation lever 18 need not be covered by the main cover 40 and may be exposed outside of the housing 10.

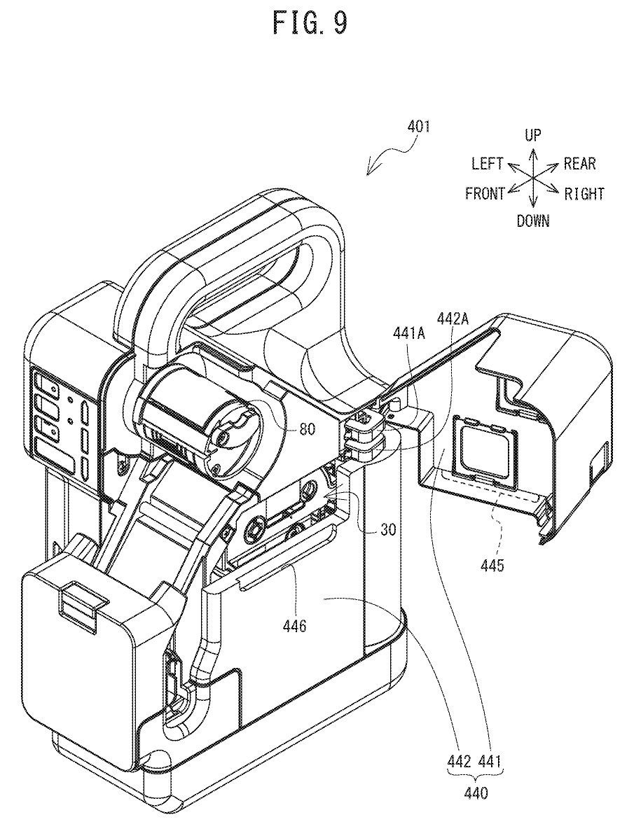

While the first cover portion 41, which covers the reel 80, and the second cover portion 42, which covers the compartment 30, are integrally formed as the main cover 40, the first cover portion 41 and the second cover portion 42 may alternatively be configured as separate bodies and be able to open and close independently. A main cover 440 of a label affixing device 401 shown in FIG. 9 is a cover in which a first cover portion 441 and a second cover portion 442 are configured as separate bodies.

The first cover portion 441 is opened and closed by a hinge 441A located at a rear end portion of the first cover portion 441. The first cover portion 441, in the closed state, is positioned to the right of the reel 80 and covers the periphery of the reel 80, including the outer radial direction of the reel 80, and, in the open state, is not disposed around the periphery of the reel 80. The second cover portion 442 is opened and closed by a hinge 442A provided at the rear end portion. The second cover portion 442 is positioned to the right of the compartment 30 and covers the compartment 30 in the closed state, and, in the open state, is not disposed to the right of the compartment 30.

A protruding overlapping portion 445 that extends downward is formed at the lower end portion of the first cover portion 441. The overlapping portion 445 constitutes a part of the first cover portion 441 and extends downward parallel to the front surface of the first cover portion 441. At the upper end portion of the second cover portion 442, a recess portion 446 in which the overlapping portion 445 is arranged is formed when the main cover 440 is in the closed state. When the main cover 440 is in the closed state, the overlapping portion 445 and the recess portion 446 are arranged so as to overlap in the left-right direction. At this time, the recess portion 446 is arranged closer to the compartment 30 than the overlapping portion 445.

When the second cover portion 442 is in the closed state, the first cover portion 441 can be opened and closed. When the first cover portion 441 is in the open state, the second cover portion 442 can be opened and closed. When the second cover portion 442 is opened while the first cover portion 441 is in the closed state, the overlapping portion 445 is pressed on by the recess portion 446. As a result, the first cover portion 441 also opens in conjunction with the opening of the second cover portion 442.

In this way, the first cover portion 441 can be opened while the second cover portion 442 remains closed. For example, when a jam or the like occurs in the release material 170, the user can immediately open the first cover portion 441 and perform maintenance on the reel 80.

On the other hand, when replacing the tape 150 or when the tape 150 is depleted, the operation of removing the tape 150 and the release material roll 175 is carried out. When the second cover portion 442 is opened, the first cover portion 441 is also opened. That is, with a single operation of opening the second cover portion 442, it is possible to perform both the operation of opening the first cover portion 441 and the operation of opening the second cover portion 442. Therefore, the label affixing device 1 can reduce the work involved in replacing the tape 150.

What is claimed is:

1. A label affixing device comprising:
a compartment included in a housing and configured to receive a medium including a label and an adhesive medium formed by an adhesive material and a release material by adhering together;
a print portion configured to print an image on the label of the medium provided from the compartment;
a convey portion configured to convey the medium printed by the print portion;
a peeling portion configured to peel the label from the medium conveyed by the convey portion and formed by adhering the label and the adhesive material together;
a winding portion configured to wind the release material with the label peeled off by the peeling portion; and,
wherein the label affixing device affixes the label, peeled off by the peeling portion, to a rod-shaped member to be affixed the label,
the winding portion includes a reel configured to wind the release material on an outer peripheral surface of the reel and a reel shaft fixed to the housing and rotatably supporting the reel,
the convey portion includes a convey roller, a drive roller configured to convey the medium by pinching the medium between a nip portion with the covey roller, and a drive shaft configured to transmit driving force to the drive roller,
when a roll with the release material wound by the winding portion is removed from the reel, the roll is removed in a first direction along an axial direction of the reel shaft,
when the medium is removed from the compartment, the medium is removed in a second direction along the axial direction of the drive shaft, and
the first direction and the second direction are a same direction.

2. The label affixing device according to claim 1, further comprising:
a cover supported by the housing, configured to rotate between a closed state covering the reel and the compartment, and an open state not covering the reel and the compartment, and configured to open and close the reel and the compartment,
wherein the cover includes a first cover portion, in the closed state, disposed around a periphery of the reel including the first direction, and, in the open state, disposed at a position away from the periphery of the reel and away from the first direction of the reel, and a second cover portion, in the closed state, disposed in the second direction of the compartment, and, in the open state, disposed at a position away from the second direction of the compartment, and
the first cover portion and the second cover portion are integrally formed.

3. The label affixing device according to claim 1, further comprising:
a cover supported by the housing and configured to rotate between a closed state covering the reel and the compartment, and an open state not covering the reel and the compartment, and configured to open and close the reel and the compartment,
wherein the cover includes
a first cover portion, in the closed state, disposed around a periphery of the reel including the first direction, and, in the open state, disposed at a position away from the periphery of the reel and away from the first direction of the reel,
a second cover portion, in the closed state, disposed in the second direction of the compartment, and, in the open state, disposed at a position away from the second direction of the compartment, and
an overlapping portion formed as a part of the first cover portion and positioned, with respect to the second cover portion, at a location opposite to the compartment and overlapping the second cover portion in the second direction when the first cover portion and the second cover portion are in the closed state,
the first cover portion and the second cover portion are configured as separate bodies,
when the first cover portion is opened, the second cover portion is maintained in the closed state, and
when the second cover portion is opened, the overlapping portion is pressed against the second cover portion such that the first cover portion opens together with the second cover portion.

4. The label affixing device according to claim 2, further comprising:
a cutting portion disposed between the convey portion and the peeling portion cuts and separates the medium; and
a lever configured to operate the cutting portion by an operation.

5. The label affixing device according to claim 4, wherein
the lever is positioned adjacent to the compartment of the housing, and
the second cover portion, when in the closed state, covers both the compartment and the lever.

6. The label affixing device according to claim 5, wherein
the convey roller releases hold of the medium at the nip portion in conjunction with an operation to open the second cover portion.

7. The label affixing device according to claim 1, wherein
an end portion of the reel shaft in a third direction opposite to the first direction is fixed to the housing, and
the reel is supported detachable from the reel shaft.

8. The label affixing device according to claim 7, wherein
the reel includes
a main body portion being tubular, including an opening extending in the first direction on a part of the outer peripheral surface of the main body portion, and supported by the reel shaft,
a lid portion arranged at an end portion of the main body portion in the first direction,
a protrusion protruding from a peripheral edge of the lid portion in the third direction, forming a part of the outer peripheral surface when arranged in the opening of the main body portion, and forming a slot that holds an end portion of the release material when the end portion of the release material is inserted between the protrusion and the opening, and
an engagement portion located at the end portion in the third direction of the opening of the main body portion, and engaging with a tip end portion of the protrusion in the third direction.

9. The label affixing device according to claim 8, wherein
the lid portion of the reel includes a removal opening that passes through the lid portion in the first direction and is connected to the slot.

10. The label affixing device according to claim 1, wherein
the medium is included in a cassette case in a roll form by winding each of the label and the adhesive material, and
the cassette case is installed in the compartment.

11. The label affixing device according to claim 1, wherein
the medium is included in a cassette case in a roll form by adhering the label and the adhesive material together, and
the cassette case is installed in the compartment.
